(19) United States
(12) Patent Application Publication
(10) Pub. No.: US 2012/0323710 A1
(43) Pub. Date: Dec. 20, 2012

(54) METHOD AND SYSTEM FOR STORING AND USING IDENTIFYING ACCOUNT INFORMATION ON AN ELECTRONIC DEVICE

(76) Inventor: William Steven Luke, Cape Coral, FL (US)

(21) Appl. No.: 13/160,553

(22) Filed: Jun. 15, 2011

(51) Int. Cl. G06Q 20/00; G06Q 30/00

(52) U.S. Cl. 705/17

(57) ABSTRACT

A method and system for creating an account and storing account information on an electronic device, such as a smart phone or tablet for use in conducting financial and other transactions. Account numbers for credit cards, debit cards, membership cards, gift cards and so forth may be displayed on a screen of the electronic device as a one-dimensional or two dimensional bar code that is then scanned by a merchant to conduct a financial transaction in the case of a purchase or to identify an individual as a member of a rewards club or other club.

### BACKGROUND OF THE INVENTION

This invention relates to credit cards, gift cards, membership cards and so forth, and more particularly to a system and method that allows an individual to safely carry all of his or her credit cards, debit cards, medical cards, identification cards, insurance cards, membership cards and so forth in an electronic device, thereby allowing the individual to use the electronic device to conduct transactions without an actual plastic card, paper card, RFID card or metal card being present.

Consumers everywhere typically have multiple credit cards, debit cards and membership cards that they carry in their wallets or purses. A person may have numerous cards they may need when making a purchase or identifying themselves as a member of a club, frequent buyer program or an owner of an insurance policy, etc. Carrying a large amount of cards can be cumbersome and can also pose a security risk if an individual's wallet or purse is stolen.

Therefore, a need exists for a system and method for storing account numbers for credit cards, debit cards, membership cards and so forth on an electronic device to provide individuals with easier access to the card information and to protect the card information from being lost or stolen.

The relevant prior art includes the following references:

| Pat. No. | | |
|---|---|---|
| (U.S. Patent References) | Inventor | Issue/Publication Date |
| 7,621,458 | Zellner et al. | Nov. 24, 2009 |
| 7,594,611 | Arrington, III | Sep. 29, 2009 |
| 7,533,828 | Ong | May 19, 2009 |
| 7,278,581 | Ong | Oct. 09, 2007 |
| 7,097,108 | Zellner et al. | Aug. 29, 2006 |
| 6,925,439 | Pitroda | Aug. 02, 2005 |
| 5,884,271 | Pitroda | Mar. 16, 1999 |
| 5,590,038 | Pitroda | Dec. 31, 1996 |
| 4,443,027 | McNeely et al. | Apr. 17, 1984 |

### SUMMARY OF THE INVENTION

The primary object of the present invention is to provide a method and system for storing account information that eliminates the need for individuals carry multiple credit cards, debit cards, and membership cards when they travel or shop.

An additional object of the present invention is to provide a method and system for storing account information on an electronic device that allows a user to display and present identifying account information to a merchant using the electronic device.

An additional object of the present invention is to provide a method and system for storing account information that prevents others from using account information stored on a lost or stolen electronic device.

The present invention fulfills the above and other objects by providing a method and system for storing account information on an electronic device, such as a smart phone or tablet. Account numbers for credit cards, debit cards, membership cards, gift cards, identification cards (such as driver's licenses, passports, etc.) and so forth may be displayed on a screen of the electronic device as a one-dimensional or two-dimensional bar code that is then scanned by a merchant to conduct a financial transaction in the case of a purchase or to identify an individual as a member of a rewards club or other club. The barcode displayed on the electronic device will vary depending on the transaction type. In simple low security transactions, such as an individual presenting themselves as a member of a retail purchase program, the electronic device may display a simple one-dimensional barcode with the original barcode provided by the card issuer's membership program. The one-dimensional barcode is then scanned by a barcode reader at a cash register or other point of sale system (“POS”). For transactions that require a higher level of safety and security, the barcode will be represented by an encrypted one-dimensional barcode or an encrypted two-dimensional barcode. In addition, the owner's photo may be displayed. The account information provided in a one-dimensional barcode or a two-dimensional barcode will meet the simple requirements used in conventional credit card and debit card transactions, such as an account owner's name, account number, expiration date and 3 or 4 digit card validation number.

Merchants that are partnered with a service provider providing the present invention to a customer may require that other data be included in the one-dimensional or two-dimensional barcode to improve security, such as the owner's membership number at the store where the transaction is taking place, Serial Number of the electronic device, correctly keyed PIN, 911 alert message if the owner is being forced to use the card against their will (this can be used to notify police or the security in the store), GPS coordinates of the electronic device at the time a transaction takes place and so forth. The electronic device may also transmit account information via infrared light, Blue Tooth radio signal and so forth. For smart devices that support RFID, infrared, or near field technology, the account information may be transmitted electronically to the cash register or POS.

If an electronic device is lost or stolen, a user may disable the electronic device and/or erase account information from the electronic device remotely to prevent unauthorized use. Alternatively, the service provider may track any unauthorized use after being notified by the user that the electronic device was stolen and notify authorities of an unauthorized use and location where the unauthorized use took place. In the event an individual purchases a new electronic device, then all of the individual's account information may be automatically transferred onto the new electronic device from the service provider's database.

In addition, the method and system of the present invention allows a user to buy electronic gift cards for other individuals, combine gift cards and store credits into a single account, track transactions and provide feedback regarding products and/or transactions to merchants that are partnered with the service provider.

For the purpose of this application, “service provider” may mean an entity that provides the system and method of the present invention for use by the public; “Individual” may mean any person who uses the system and method of the present invention on an electronic device; and “card issuer” may mean any entity that provides or issues credit cards, debit cards, gift cards, store credits, membership cards, identification cards and so forth.

The above and other objects, features and advantages of the present invention should become even more readily apparent to those skilled in the art upon a reading of the following detailed description in conjunction with the drawings wherein there is shown and described illustrative embodiments of the invention.

### BRIEF DESCRIPTION OF THE DRAWINGS

In the following detailed description, reference will be made to the attached drawings in which:

FIG. 1 is a flow chart showing steps for creating an account and storing identifying account information on an electronic device and central database using the method and system of the present invention;

FIG. 2 is a flow chart showing steps for using identifying account information stored on an electronic device and central database to conduct transactions using the method and system of the present invention;

FIG. 3 is a flow chart showing steps for protecting stolen or lost identifying account information stored on an electronic device using the method and system of the present invention;

FIG. 4 is a flow chart showing steps for protecting compromised identifying account information stored on an electronic device and automatically receiving replacement identifying account information using the method and system of the present invention;

FIG. 5 is a flow chart showing steps for automatically entering identifying account information and service provider software onto a new electronic device using the method and system of the present invention;

FIG. 6 is a flow chart showing steps for buying an individual a gift card using the method and system of the present invention;

FIG. 7 is a flow chart showing steps for adding a store credit to an individual's account with the service provider using the method and system of the present invention;

FIG. 8 is an example of a computer environment, in which the method and system of the present invention operates;

FIG. 9 is a front view of an electronic device displaying a user setup screen of the present invention;

FIG. 10 is a front view of an electronic device displaying a user login screen of the present invention;

FIG. 11 is a front view of an electronic device displaying a user registration screen of the present invention;

FIG. 12 is a front view of an electronic device displaying an icon for accessing the service provider's software of the present invention;

FIG. 13 is a front view of an electronic device displaying a card type selection screen of the present invention;

FIG. 14 is a front view of an electronic device displaying a credit card display screen of the present invention;

FIG. 15 is a front view of an electronic device displaying a pin entry screen of the present invention;

FIG. 16 is a front view of an electronic device displaying a two-dimensional barcode screen of the present invention;

FIG. 17 is a front view of an electronic device displaying a transaction amount entry screen of the present invention;

FIG. 18 is a front view of an electronic device displaying a transaction summary screen of the present invention;

FIG. 19 is a front view of an electronic device displaying a membership card screen of the present invention;

FIG. 20 is a front view of an electronic device displaying a membership card option screen of the present invention; and

FIG. 21 is a front view of an electronic device displaying a one-dimensional bar code screen of the present invention.

### DESCRIPTION OF THE PREFERRED EMBODIMENTS

For purposes of describing the preferred embodiment, the terminology used in reference to the numbered accessories in the drawings is as follows:
1. individual creates account
2. personal information is stored in a central database
3. individual downloads software onto electronic device
4. individual selects from a list of card issuers partnered with service provider
5. service provider automatically downloads account information
6. card issuer that individual wants to add card for is not partnered with service provider
7. individual submits request for card issuer to partner with service provider
8. request is displayed on service provider's website
9. request is accepted by card issuer
10. card issuer provides card information to service provider
11. card information is stored on central database and electronic device
12. individual creates icon for card issuer
13. individual manually enters information from card into account
14. individual opens software on electronic device
15. individual selects a category
16. individual selects credit card category
17. individual selects credit card
18. individual enters pin number or password
19. barcode is created
20. barcode is scanned
21. option to enter transaction amount
22. transaction amount is stored in central database
23. individual selects debit card category
24. individual selects debit card
25. individual enters pin number or password
26. barcode is created
27. barcode is scanned
28. individual selects membership card category
29. individual selects membership card
30. individual selects display membership information
31. barcode is created
32. barcode is scanned
33. individual select membership and purchase option
34. individual performs steps for performing credit/debit card transaction
35. barcode is created
36. Electronic device is lost or stolen
37. service provider is contacted
38. electronic device is disabled
39. card issuer is contacted
40. electronic device is monitored for use
41. unauthorized use id detected
42. bar code indicating device is stolen is created
43. authorities are alerted
44. card has been compromised
45. individual contact card issuer
46. card issuer issues new card number to service provider
46a. service provider updates the new card information to the individual's electronic device
47. new electronic device is purchased
48. individual contact service provider
49. new software and card information is down loaded
49a. the old electronic device is left enabled or disabled based on the individual's preferences
50. gift card is purchased
51. card issuer transmits gift card information to service provider
52. service provider transmits gift card information to individual's account
53. gift card is redeemed using electronic device
53a. full amount of the gift card is not used
53b. service provider updates the electronic device
54. product is returned to merchant
55. merchant submits store credit information to service provider
56. service provider transmits store credit information to individual's account
57. store credit is redeemed using electronic device
57a. full amount of the credit is not used
57b. service provider updates the electronic device
58. service provider server
59. electronic device
60. internet
61. service provider central database
62. card issuer server
63. card issuer central database
64. My-1-Card icon on electronic device
65. two-dimensional barcode
66. one-dimensional barcode

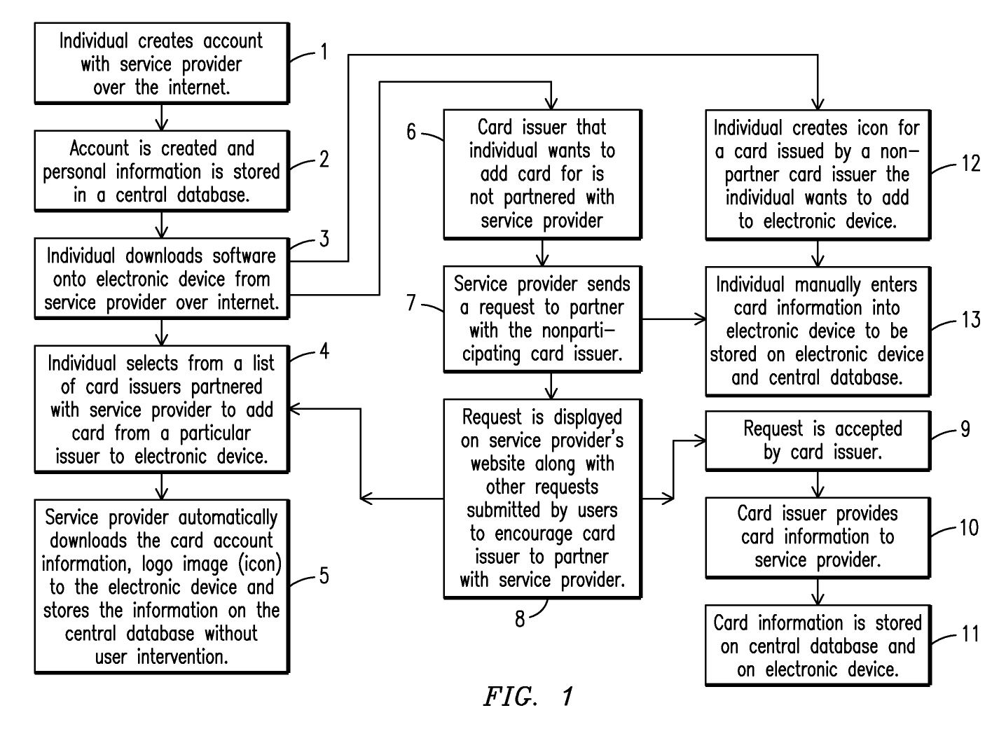

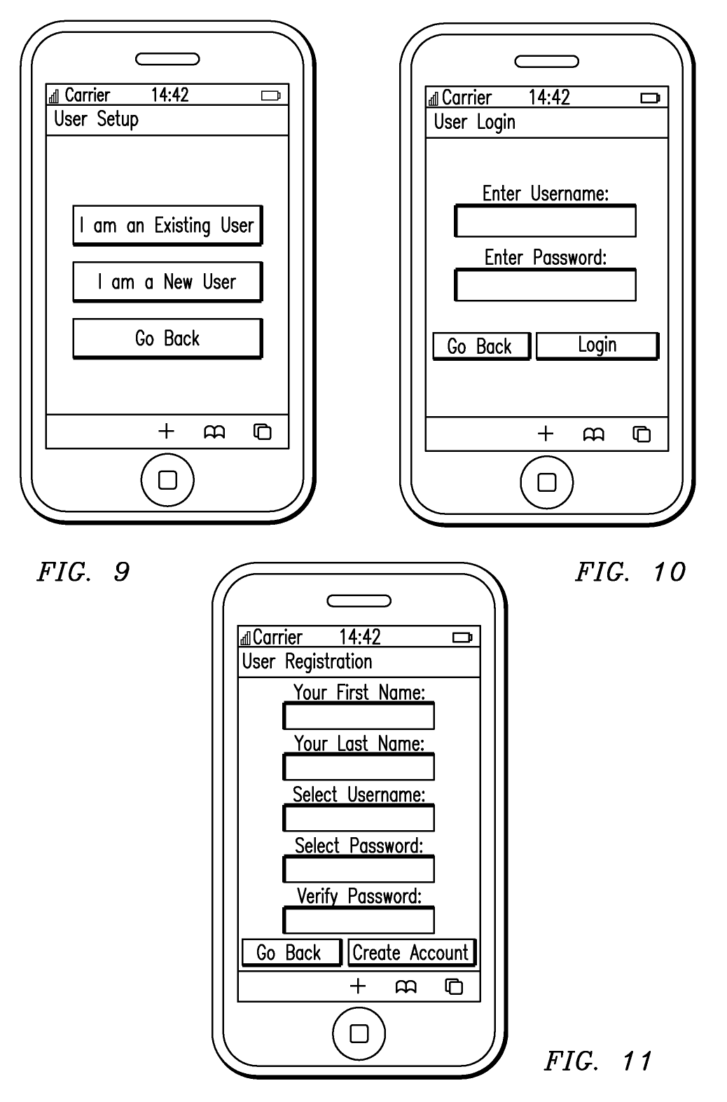

With reference to FIG. 1, a flow chart showing steps for creating an account and storing identifying account information on an electronic device and central database using the method and system of the present invention is illustrated. First, an individual uses an electronic device, such as a smart phone, tablet and so forth to create an account with a service provider over the internet 1 by providing the service provider with personal information, such as name, address, email, username, password and so forth (as shown in FIGS. 9 & 11). Then, the service provider creates an account that may be accessed by the user with a pin number or password and stores the personal information provided in step 1 in a central database 2, thereby creating an account for the individual. Next, the individual downloads software onto the electronic device from the service provider over the internet 3. Then, the individual may select from a list of card issuers, such as credit card companies, companies having memberships or companies having reward cards, who are partnered with the service provider to add an icon for a particular card issuer to the electronic device 4. Next, the service provider automatically downloads the card account information from the card issuer to the electronic device and stores the information in the central database 5.

If a card issuer of whom the individual wants to add card information for is not partnered with the service provider 6, then the individual may submit a request for the card issuer to partner with the service provider 7 and the request may then be displayed on the service provider's website along with other requests submitted by users 8. The information displayed on the website will show the number of individuals who have an interest in the card issuer partnering with the service provider, thereby encouraging card the issuer to partner with the service provider. The individual may then manually enter the card information into the electronic device to be stored on the electronic device and on the central database 13. If the card issuer partners with the service provider 9, then the card issuer will provide the card information to the service provider 10 and the card information will be stored on the electronic device and in the central database 11

Alternatively, an individual may create an icon for a particular card issuer on the electronic device 12. Then, the individual may manually enter information from the card into the electronic device so it is stored on the electronic device and in the central database 13.

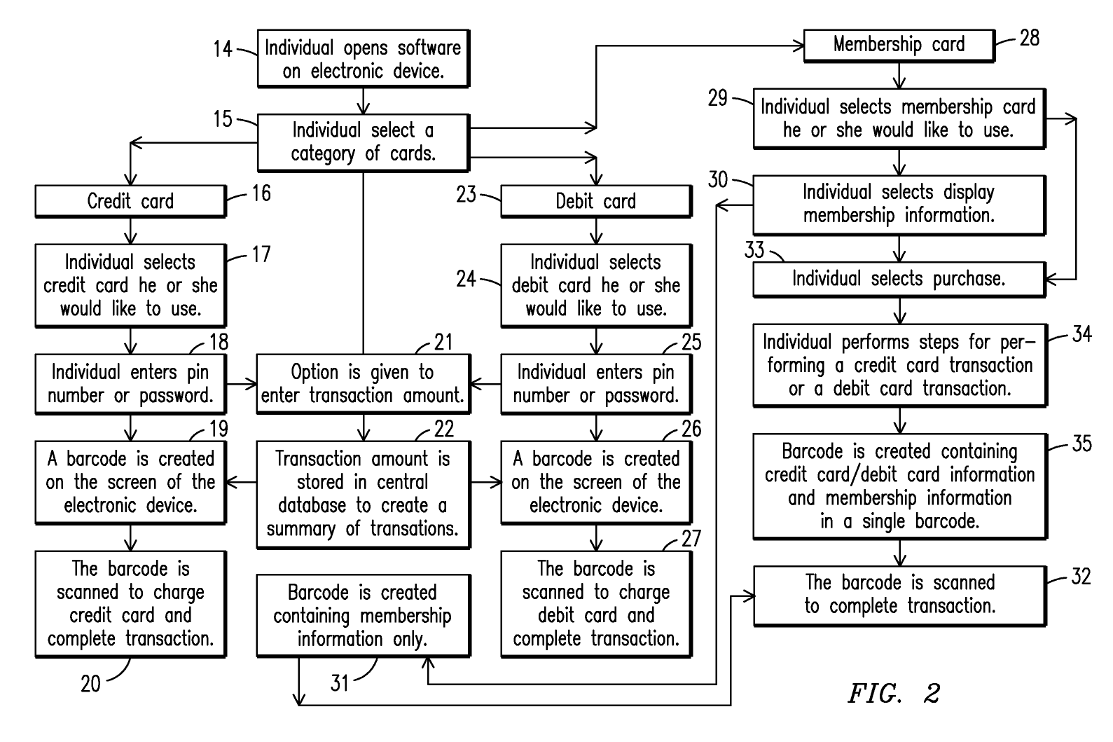

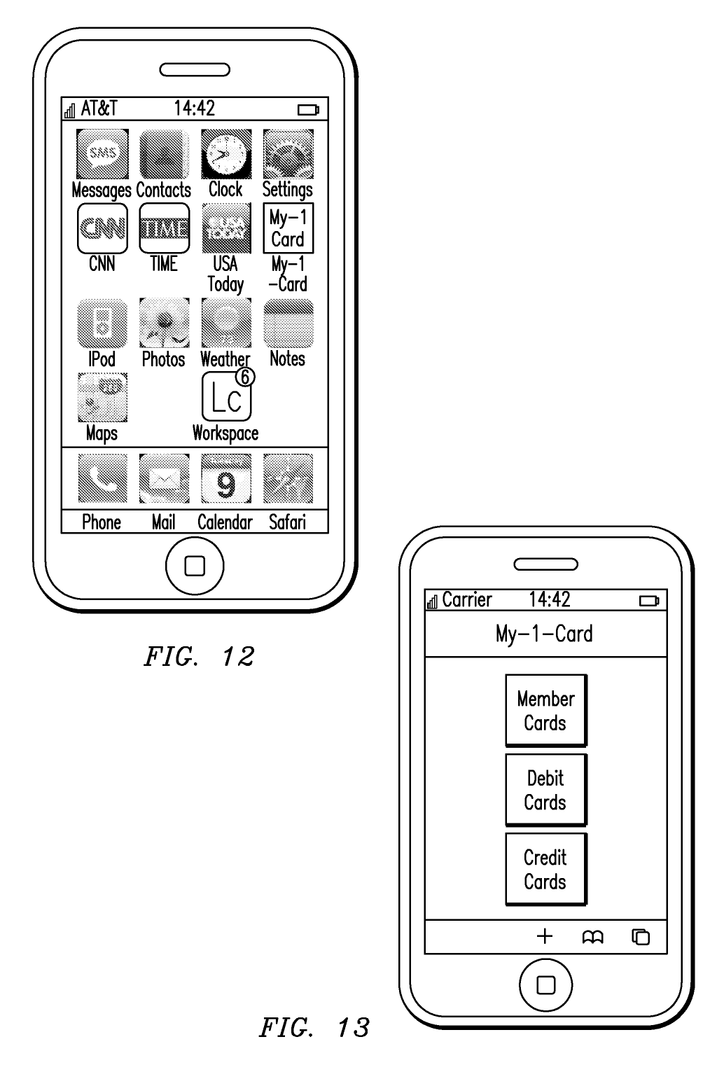

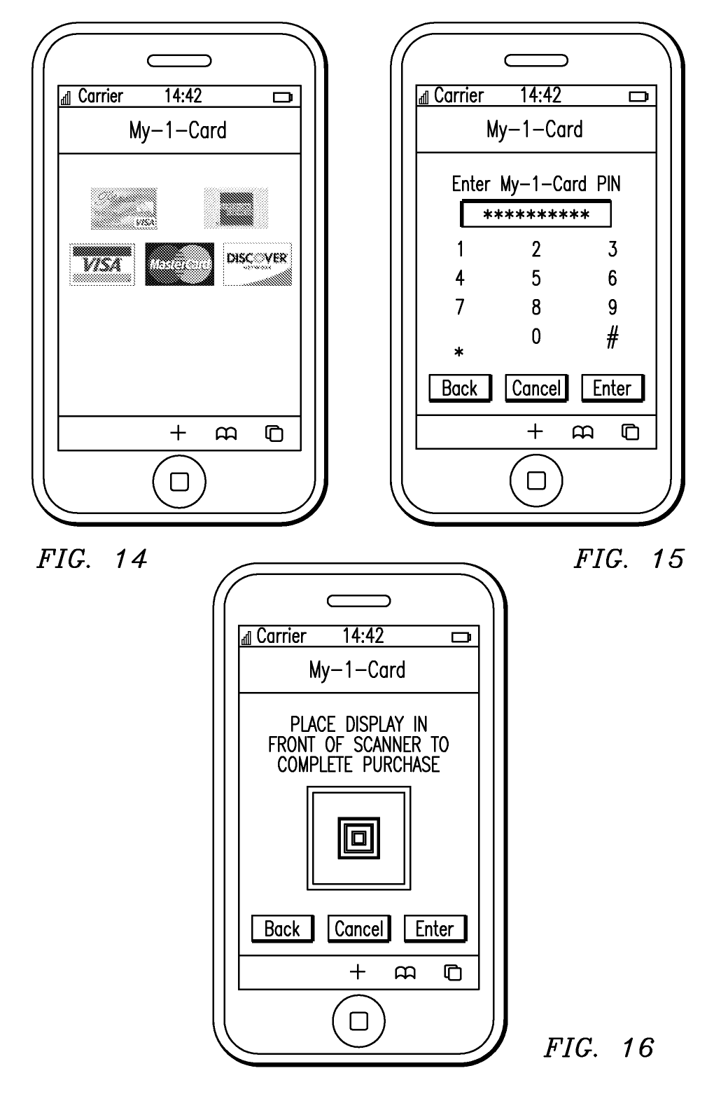

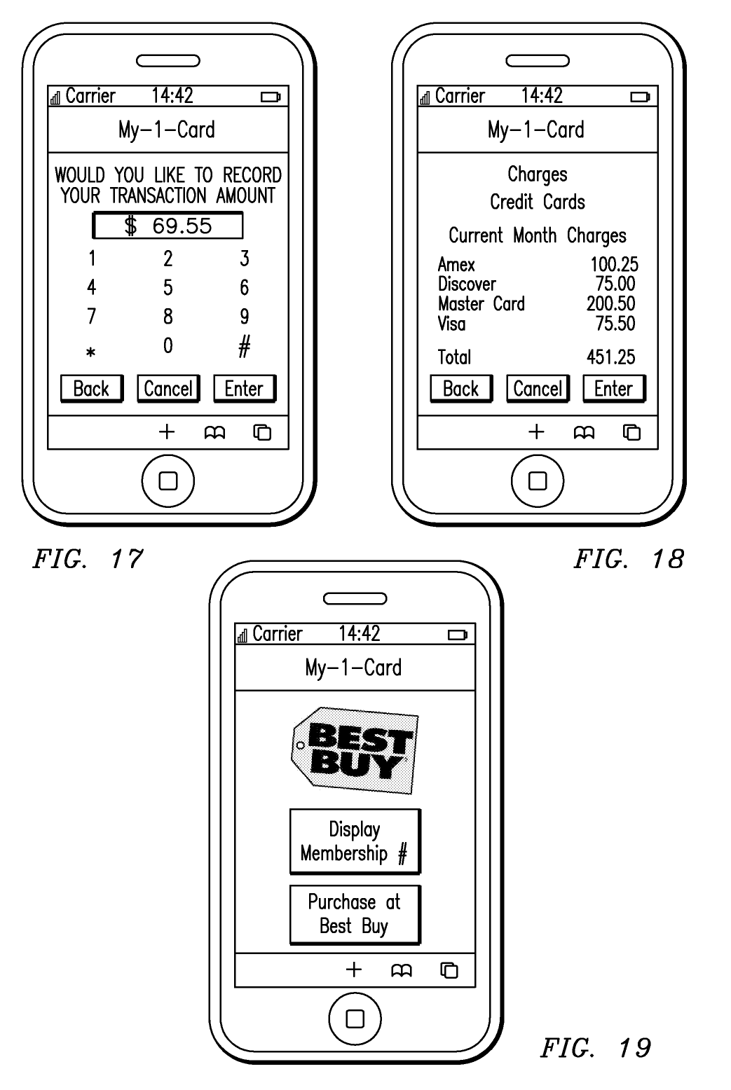

With reference to FIG. 2, a flow chart showing steps for using identifying account information stored on an electronic device and central database to conduct transactions using the method and system of the present invention is illustrated. First, an individual opens software on an electronic device, preferably by pressing an icon displayed on the electronic device (as shown in FIG. 12) and logs into his or her account 14 (as shown in FIG. 10). Then, the individual selects a category of cards 15, such as a credit card, debit card, membership card, gift card, store credit card and so forth (as shown in FIG. 13). If the individual chooses a credit card category 16, then the individual may select from one or more credit cards stored on the electronic device 17 (as shown in FIG. 14). Next, the individual enters a pin number or password to authorize a transaction 18 (as shown in FIG. 15). Then, a barcode, which may be one-dimensional, two-dimensional, encrypted and so forth, having the credit card account information therein is created on the screen of the electronic device 19 (as shown in FIG. 16). Finally, the barcode is scanned to charge the credit card and complete the transaction 20. An option may be given after step 18 to allow the individual to enter the transaction amount into the electronic device 21 (as shown in FIG. 17). If the individual chooses the latter option, then the individual enters the transaction amount and the transaction amount is stored in the central database to create a summary of transactions 22 (as shown in FIG. 18). Then, the individual continues with step 19.

If the individual chooses a debit card category 23, then the individual may select from one or more debit cards stored on the electronic device 24. Next, the individual enters a pin number or password to authorize a transaction 25. Then, a barcode having the debit card information therein is created on the screen of the electronic device 26. Finally, the barcode is scanned to charge the debit card and complete the transaction 27. An option may be given after step 25 to allow the individual to enter the transaction amount into the electronic device 20. If the individual chooses the latter option, then the individual enters the transaction amount and the transaction amount is stored in the central database to create a summary of transactions 21. Then, the individual continues with step 26.

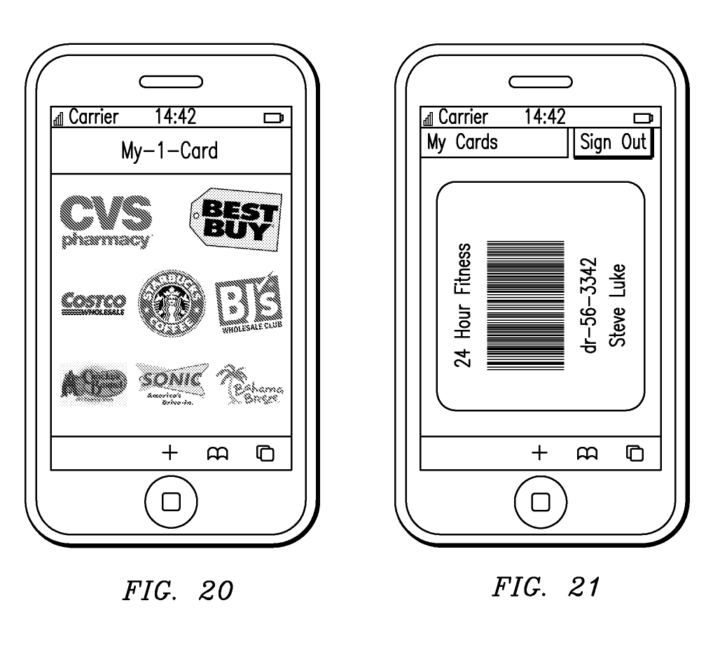

If the individual chooses a membership card category 28, then the individual may select from one or more membership cards stored on the electronic device 29 (as shown in FIG. 19). Next, the individual is given the option of choosing between only displaying the membership information or displaying the membership information and conducting a financial transaction at the same time (as shown in FIG. 20). If the individual chooses to display the membership information only 30, then a barcode is created containing the information and displayed on the electronic device 31 (as shown in FIG. 21). Then, the barcode is scanned to complete the transaction 32. If the individual chooses to display the membership information and to conduct a financial transaction 33, then the individual performs the steps for performing a credit card transaction or the steps for performing a debit card transaction 34. Next, a barcode is created containing credit card information or debit card information and membership information 35. Finally, the barcode is scanned to complete the transaction 32.

With reference to FIG. 3, a flow chart showing steps for protecting stolen or lost identifying account information stored on an electronic device using the method and system of the present invention is illustrated. First, an individual loses an electronic device or an electronic device is stolen from the individual having the service provider's software and his or her identifying account information stored thereon 36. Next, the individual contacts the service provider, via the internet, telephone and so forth, to inform the service provider that the electronic device was lost or stolen 37. Alternatively, the individual may contact the card issuer who may also contact the service provider 39 who may the contact the service provider. After the service provider is contacted, the electronic device may be remotely disabled and/or the identifying account information may be erased from the electronic device remotely by the service provider 38 through the service provider's server via the internet, 3G communications 4G communications and so forth. Alternatively, the service provider may monitor the electronic device for unauthorized use 40 through the service provider's server. If unauthorized use is detected 41, a special bar code is created that alerts a merchant the electronic device is stolen 42. The barcode may also indicate if the owner is being forced to use the electronic device. The warning message is hidden within the barcode, thereby allowing only an individual scanning the barcode to retrieve the message. Finally, authorities are alerted to the unauthorized use and given the location where the unauthorized use occurred 43.

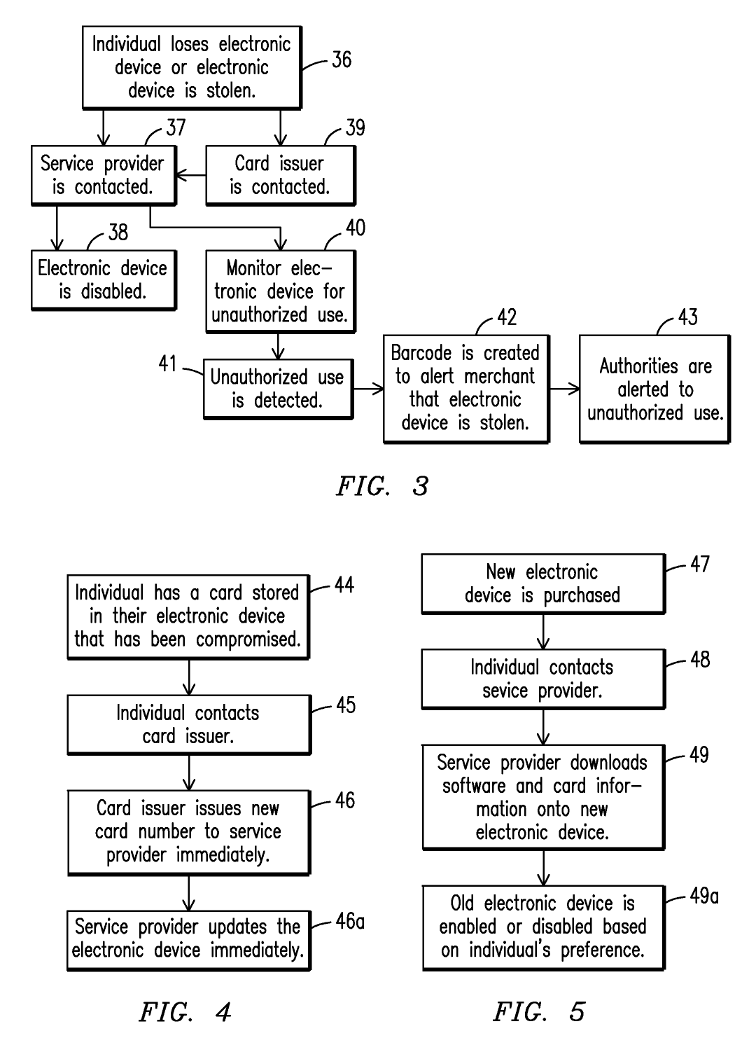

With reference to FIG. 4, a flow chart showing steps for protecting compromised identifying account information stored on an electronic device and automatically receiving a replacement identifying account information using the method and system of the present invention is illustrated. First, the user has a card stored in their electronic device that has been compromised 44. For example, a credit card that has unauthorized purchases charged to it. Then, the individual contacts the card issuer 45. Finally, the card issuer issues a new card number immediately via electronic means to the service provider 46 and the service provider updates the new card information to the individual's electronic device 46a so that the individual can have the new card number immediately, thereby eliminating the wait for a new card to be sent in the mail.

With reference to FIG. 5, a flow chart showing steps for automatically entering identifying account information and service provider software onto a new electronic device using the method and system of the present invention is illustrated. First, a new electronic device is purchased by an individual who has a pre-existing account with the service provider 47. Next, the individual contacts the service provider via telephone, Internet and so forth to inform the service provider that the individual needs to install the service provider's software and card information on the new electronic device from the service provider's central database 48. Then, the service provider downloads the software and card information onto new electronic device through the service provider's server 49. Finally the old electronic device is left enabled or disabled based on the individual's preferences 49a.

With reference to FIG. 6, a flow chart showing steps for buying an individual a gift card using the method and system of the present invention is illustrated. First, a gift card is purchased from a partnered card issuer 50. Then, the gift card information, such as store name, credit amount and so forth is electronically transmitted to the service provider via the internet 51. Next, the service provider adds the gift card to the electronic device of the individual receiving the gift card 52. Then, the gift card may be used by generating a barcode on the electronic device to be scanned by a POS system 53. If the full amount of the gift card is not used, the POS system updates the service provider with the balance information for the gift card 53a. Then, the service provider updates the electronic device with the current balance information 53b and the individual may repeat step 53 to use the remaining balance.

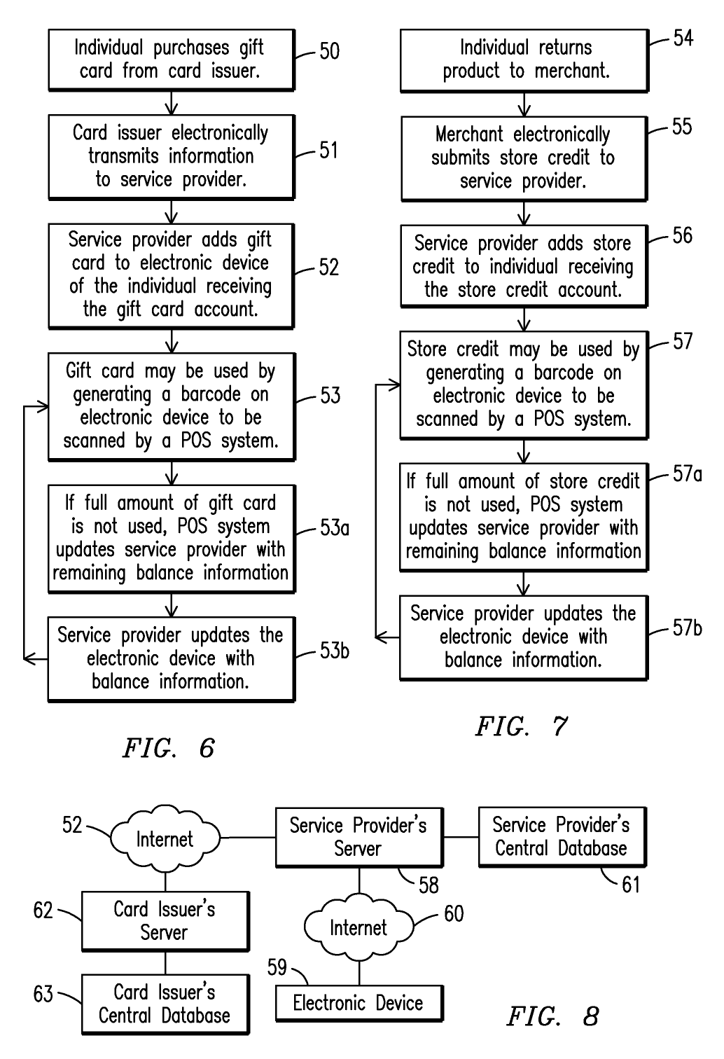

With reference to FIG. 7, a flow chart showing steps for adding a store credit to an individual's account with the service provider using the method and system of the present invention is illustrated. First, an individual returns an item to a store 54. Then, the store issues a store credit and electronically transmits the information to the service provider via the internet 55. Next, the service provider either adds the credit to an existing account for the merchant or creates a new icon for the merchant and adds the credit to the individual's electronic device 56. Then, the credit may be used by generating a barcode on the electronic device to be scanned by a POS system 57. If the full amount of the credit is not used, the POS system updates the service provider with the balance information for the credit 57a. Then, the service provider updates the electronic device with the current balance information 57b and the individual may repeat step 57 to use the remaining balance.

With reference to FIG. 8, an example of a computer environment, in which the method and system of the present invention operates is illustrated. A server 58 operated by the service provider hosts a website on which potential members and members may visit and/or log into via electronic devices 51, such as computers, smart phones, tablets and so forth, over the internet 52. The service provider's central database 53 is connected to the server 50 operated by the service provider. The service provider may also communicate through the internet 52 with one or more card issuers through the card issuer's server 54, which is connected to the card issuer's central database 55.

In FIG. 9, a front view of an electronic device displaying a user setup screen of the present invention is illustrated, which is self explanatory when viewed in conjunction with the description of the method and system described herein.

In FIG. 10, a front view of an electronic device displaying user login screen of the present invention is illustrated, which is self explanatory when viewed in conjunction with the description of the method and system described herein.

In FIG. 11, a front view of an electronic device displaying a user registration screen of the present invention is illustrated, which is self explanatory when viewed in conjunction with the description of the method and system described herein.

In FIG. 12, a front view of an electronic device displaying an icon for accessing the service provider's software of the present invention is illustrated, which shows a My-1-Card icon 64.

In FIG. 13, a front view of an electronic device displaying a card type selection screen of the present invention is illustrated, which is self explanatory when viewed in conjunction with the description of the method and system described herein.

In FIG. 14, a front view of an electronic device displaying a credit card display screen of the present invention is illustrated, which is self explanatory when viewed in conjunction with the description of the method and system described herein.

In FIG. 15, a front view of an electronic device displaying pin entry screen of the present invention is illustrated, which is self explanatory when viewed in conjunction with the description of the method and system described herein.

In FIG. 16, a front view of an electronic device displaying a two-dimensional barcode 65 screen of the present invention is illustrated.

In FIG. 17, a front view of an electronic device displaying a transaction amount entry screen of the present invention is illustrated, which is self explanatory when viewed in conjunction with the description of the method and system described herein.

In FIG. 18, a front view of an electronic device displaying a transaction summary screen of the present invention is illustrated, which is self explanatory when viewed in conjunction with the description of the method and system described herein.

In FIG. 19, a front view of an electronic device displaying a membership card screen of the present invention is illustrated, which is self explanatory when viewed in conjunction with the description of the method and system described herein.

In FIG. 20, a front view of an electronic device displaying a membership card option screen of the present invention is illustrated, which is self explanatory when viewed in conjunction with the description of the method and system described herein.

Finally in FIG. 21, a front view of an electronic device displaying a one-dimensional bar code 66 screen of the present invention is illustrated.

It is to be understood that while a preferred embodiment of the invention is illustrated, it is not to be limited to the specific form or arrangement of parts herein described and shown. It will be apparent to those skilled in the art that various changes may be made without departing from the scope of the invention and the invention is not to be considered limited to what is shown and described in the specification and drawings.

Having thus described my invention, I claim:

1. A method for storing physical identifying account information on an electronic device and transforming the identifying account information into a readable electronic medium for conducting a financial transaction, said method comprising the steps of:
a. an individual storing identifying account information on an electronic device;
b. the individual beginning a transaction with a merchant;
c. the electronic device transforming the identifying account information into a barcode displayed on the electronic device;
d. the individual presenting said barcode to the merchant;
e. said merchant scanning the barcode displayed on the electronic device, thereby receiving the identifying account information; and
f. completing the transaction.

2. The method of claim 1 further comprising a step before step a of:
the individual creating an account over the internet with a service provider using the electronic device.

3. The method of claim 2 further comprising the steps of:
the individual downloading software from the service provider onto the electronic device; and
the identifying account information being stored on the service provider's database.

4. The method of claim 1 further comprising the steps of:
the individual submitting a request to the service provider that the individual wants a card issuer to partner with the service provider; and
said service provider publicly displaying the request on the service provider's website.

5. The method of claim 1 further comprising the step of:
the identifying account information is entered into the electronic device manually.

6. The method of claim 2 further comprising the steps of:
a request being made to the service provider to automatically add identifying account information for an account with a card issuer;
the service provider sending a request for the identifying account information being sent to the card issuer;
the card issuer electronically sending the requested identifying account information to the service provider; and
the service provider electronically sending the requested identifying account information to the electronic device.

7. The method of claim 3 further comprising the steps of:
the individual acquiring a new electronic device;
the individual downloading software from the service provider onto the new electronic device; and
the individual's identifying account information stored on the service provider's database being electronically transferred to individual's new electronic device.

8. The method of claim 1 further comprising a step before step c of:
the individual being required to enter a pin number into the electronic device.

9. The method of claim 1 wherein:
said identifying account information is for a credit card account.

10. The method of claim 1 wherein:
said identifying account information is for a debit card account.

11. The method of claim 1 wherein:
said identifying account information is for a membership card account.

12. The method of claim 1 wherein:
said identifying account information is for a gift card account.

13. The method of claim 1 wherein:
said identifying account information is for a store credit account.

14. The method of claim 1 wherein:
said identifying account information is for an identification card.

15. The method of claim 1 further comprising a step of
the electronic device being lost; and
the electronic device being remotely disabled so a third party cannot access identifying account information stored on the electronic device.

16. The method of claim 2 further comprising a step of:
the electronic device being lost; and
the electronic device being monitored remotely for unauthorized use by the service provider.

17. The method of claim 1 wherein:
said barcode is a one-dimensional barcode.

18. The method of claim 1 wherein:
said barcode is a two-dimensional barcode.

19. The method of claim 1 wherein:
said barcode is encrypted.

20. A system for storing physical identifying account information on an electronic device and transforming the identifying account information into an readable electronic medium for conducting conduct transactions, said system comprising:
identifying account information being stored on an electronic device;
beginning a transaction with a merchant;
the identifying account information being transformed into a barcode displayed on the electronic device;
said barcode being presented to the merchant;
said barcode being scanned by the merchant, thereby causing the merchant to receive the identifying account information; and
the transaction being completed.

21. The system of claim 20 further comprising:
an account being created over the internet with a service provider.

22. The system of claim 21 further comprising:
software from the service provider being downloaded onto the electronic device; and
the identifying account information being stored on the service provider's database.

23. The system of claim 20 further comprising:
a request being submitted to the service provider that an individual wants a card issuer to partner with the service provider; and
the request being displayed on the service provider's website.

24. The system of claim 20 further comprising:
the identifying account information being entered into the electronic device manually.

25. The system of claim 21 further comprising:
a request being made to the service provider to automatically add identifying account information for an account with a card issuer;
the service provider sending a request for the identifying account information being sent to the card issuer;
the card issuer electronically sending the requested identifying account information to the service provider; and
the service provider electronically sending the requested identifying account information to the electronic device.

26. The system of claim 22 further comprising:
an individual acquiring a new electronic device;
the individual downloading software from the service provider onto the new electronic device; and
the individual's identifying account information stored on the service provider's database being electronically transferred to the individual's new electronic device.

27. The system of claim 20 further comprising:
a pin number being entered into the electronic device.

28. The system of claim 20 wherein:
said identifying account information is for a credit card account.

29. The system of claim 20 wherein:
said identifying account information is for a debit card account.

30. The system of claim 20 wherein:
said identifying account information is for a membership card account.

31. The system of claim 20 wherein:
said identifying account information is for a gift card account.

32. The system of claim 20 wherein:
said identifying account information is for a store credit account.

33. The system of claim 20 wherein:
said identifying account information is for an identification card.

34. The system of claim 20 further comprising:
the electronic device being lost; and
the electronic device being remotely disabled so a third party cannot access identifying account information stored on the electronic device.

35. The system of claim 21 further comprising:
the electronic device being lost; and
the electronic device being monitored remotely for unauthorized use by the service provider.

36. The system of claim 20 wherein:
said barcode is a one-dimensional barcode.

37. The method of claim 20 wherein:
said barcode is a two-dimensional barcode.

38. The system of claim 20 wherein:
said barcode is encrypted.
